(19) United States
(12) Patent Application Publication
(10) Pub. No.: US 2004/0172541 A1
(43) Pub. Date: Sep. 2, 2004

(54) IC card having security control

(75) Inventors: Kazunori Ando, Hiratsuka (JP); Hiroshi Yamauchi, Hadano (JP); Yasuhisa Shibata, Hadano (JP); Toshiki Oshima, Hadano (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/723,390

(22) Filed: Nov. 25, 2003

(30) Foreign Application Priority Data
Nov. 26, 2002 (JP) 2002-341877

(51) Int. Cl. H04L 9/00

(52) U.S. Cl. 713/176

(57) ABSTRACT

In an IC card to be used for individual authentication or settlement, it becomes necessary to prevent unfair use by any other person than the owner due to loss, theft or the like. For this reason, individual authentication information of the user of the IC card concerned is inputted; the above-described individual authentication information inputted is collated with individual authentication information of the user of the IC card registered in advance; when the collation results in coincidence, the IC card concerned will be made valid during a predetermined term of validity to make the IC card concerned usable. As the individual authentication information at this time, biometrics information on the finger print, iris, retina and voiceprint of the user is adequate.

### BACKGROUND OF THE INVENTION

The present invention relates to an IC card and a system for using the IC card.

In information society, there has been increasing a case where electronic settlement or information interchange is performed through Internet from information equipment such as personal computers by taking advantage of the IC card. In this case, in order to prevent unfair use of user ID and use under the disguise, an owner has been confirmed through the use of an IC card having a higher security function than pass words and magnetic cards.

Even in the IC card, however, in the case of loss, theft and the like, nothing can be done to collate the owner, but it falls short of preventing unfair use or use under the disguise. For this reason, a function for identifying the owner is requested for the IC card itself. As such a technique, in Japanese Patent Laid-Open Nos. 2000-36027 and 2002-150256, there has been disclosed invention in which an IC card has a module for detecting a finger print of the owner and a function for collating it with a finger print which has been registered in advance, and if when the IC card is used, the principal's finger print coincides with a finger print which has been read and registered, the IC card becomes usable.

Also, in Japanese Patent Laid-Open No. H11 (1999)-306301, there has been disclosed invention in which with the objective of preventing continuous unfair use of an IC card by any other person than the genuine card owner, a security status for showing a valid authentication state after termination of authentication of the card owner continues only for a predetermined time period. Also, there has been disclosed invention in which after a lapse of the above-described predetermined time period, the security status is returned to the original state, or the application file in question will be blocked up.

In the above-described Japanese Patent Laid-Open Nos. 2000-36027 and 2002-150256, there has been disclosed a function in which an IC card has a module for detecting a finger print of the owner and a function for collating it with a finger print which has been registered in advance, and if when the IC card is used, the principal's finger print is read and it coincides with the finger print which has been registered, the IC card becomes usable. In this invention, however, if an IC card which has read the finger print and become usable should be lost/stolen, it will be impossible to prevent the IC card from being unfairly used or used under the disguise.

Also, in the Japanese Patent Laid-Open Nos. 2000-36027, it has been disclosed that if the principal's finger print of the IC card is read and coincides with the finger print registered, there is provided a function for turning ON driving of the IC card body. However, no consideration has been given to a term of validity of the IC card after the use thereof. Similarly, even in the Japanese Patent Laid-Open No. 2002-150256, no consideration has been given to a term of validity of the IC card after the use. For this reason, when the IC card is lost after collated, when lost or stolen, unfair use and use under the disguise of the IC card cannot be prevented, depending upon the value of the term of validity.

On the other hand, in Japanese Patent Laid-Open No. H11(1999)-306301, an IC card connected to an IC card reader is constituted such that after termination of authentication by the owner, a security status showing an authentication valid state continues only for a predetermined time period. However, a time period of the authentication valid state, in other words, a term of validity effective for preventing unfair use/use under the disguise when the IC card is lost/stolen after collated by the principal cannot be mentioned in the same breath. Depending upon the value of term of validity, use application/how to use of the IC card is limited, whereby it is conceivable that ease of use of the IC card is impaired or it becomes difficult to secure a sufficient security level among others.

### SUMMARY OF THE INVENTION

Thus, it is an object of the present invention to cope with the above-described request and to provide an IC card capable of preventing unfair use/use under the disguise (hereinafter, may be abbreviated to unfair use simply) even if the IC card may be lost or stolen after collated by the owner, and in addition, excellent in ease of use, and capable of securing a sufficient security level.

According to the present invention, there is provided an IC card having a collation function of biometrics data to be used for collation of the owner of the IC card, wherein it is an IC card having a security control function in which conditions for continuous use of the IC card after it has become usable can be set through the use of a plurality of parameters. As the plurality of parameters, there are named, for example, a term of validity (time period), an object of use of an IC card (or each application program therein), a security level, use environment of the IC card (or each application program therein) and the like. These parameters are prepared one each or in plurality in advance, and a term of validity in which it can be continuously used, or a condition for further causing it to continue is set by a combination of the term of validity and another parameter.

An IC card according to the present invention has a biometrics (human fingerprint, voiceprint, iris print, retina print and the like) authentication module which can be confirmed by the owner; a function for collating it with the owner's biometrics data registered in advance; a function in which the IC card becomes usable in a case where when the IC card is used, biometrics data of the owner is read and it coincides with the biometrics data registered; and a function for erasing only the read biometrics data after a lapse of a predetermined time period to limit a time period for use of the IC card. Thereby, after a lapse of the predetermined time period, the IC card will not be able to be used if the biometrics data is not collated again, but it is possible to prevent unfair use/use under the disguise even when lost/stolen after collated by the principal.

As a time period for erasing only the read biometrics data, that is, a term of validity, any arbitrary time period can be set in advance.

For example, various objects of use of the IC card are made into parameters, and any arbitrary time period can be set in advance in accordance with various objects of use. Thereby, in consideration of a time period necessary for collation of the principal before the IC card is used or a shortest time period in which there is a possibility that the IC card is lost or stolen and unfair use/use under the disguise occurs after collated by the principal in accordance with each of those objects of use, it is possible to set an optimum time period until erasing adapted to the object of use or the ease of use of the IC card.

Further, the security level is made into one of the parameters, and the security level in the collation by the principal of biometrics is made possible to select from among a plurality of security levels. In the case of, for example, the finger print, it is possible to set in such a manner that levels of features to be collated or a number of fingers to be used for collation is changed in accordance with the object of use of the IC card.

Or by combining the above, by combining the security level of biometrics with a time period setting function of erasing only the biometrics data among others, it is possible to set collation of the principal and security level more suitable for the object of use and ease of use of the IC card.

### BRIEF DESCRIPTION OF THE DRAWINGS

FIG. 1 is a schematic view showing an IC card having a function of reading biometrics data according to an example of the present invention;

FIG. 2 is a block diagram explaining each functional region within the IC card of FIG. 1; and

FIG. 3 is a flow chart for explaining a function for reading the biometrics data on the IC card according to an example of the present invention to make it usable for a predetermined time period.

### DETAILED DESCRIPTION OF THE PREFERRED EMBODIMENTS

Hereinafter, with reference to the drawings, the description will be made of an embodiment of the present invention.

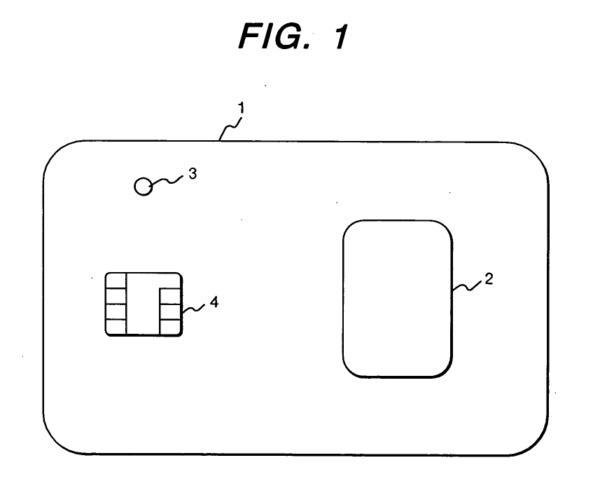

First, in FIG. 1, the description will be made of an outline of the IC card according to the present example. In the present embodiment, the IC card 1 has one finger print authentication module 2 on the surface. Since it is used in order to confirm the owner, the finger print authentication module 2 has exemplified the finger print as the biometrics data in the present example, but a voiceprint, an iris print, a retina print and the like, which are other biometrics, maybe also exemplified. Also, the finger print authentication module 2 may be either a static electricity system or an optical system, and when the finger print module 2 should be small and thin, the static electricity system is preferable.

On authenticating, a finger of the owner is placed on the finger print authentication module 2 to read the finger print data, and it is collated with finger print data of the owner registered in advance. When the collation results in coincide, a state indication lamp 3 is lighted to display that the IC card is in a usable state. When the state indication lamp 3 is put out, it means that the IC card 1 is not usable. In the present example, the state indication lamp 3 is a lamp such as LED, and any lamp may be taken as long as it has a function capable of notifying the owner of whether or not it is usable. For example, a system in which a small-sized liquid crystal module is packaged to display an usable state on a liquid crystal screen, or a system in which a speaker, a buzzer or the like is packaged to notify through voice guidance or buzzer sound when it becomes usable may be adopted.

An IC chip 4 is a module for reading the IC card 1 by an IC card reader/writer (not shown). In the present example, the IC card is of a contact type using an IC chip, but a non-contact type using a radio communication function may be used. This IC chip 4 has an application program corresponding to a plurality of objects of use, and may perform an authentication operation corresponding to respective application, and give and receive authentication information/card information by connecting to an IC card reader/writer (not shown). In this case, the object of use of the IC card becomes definite when the IC card is connected to the IC card reader/writer.

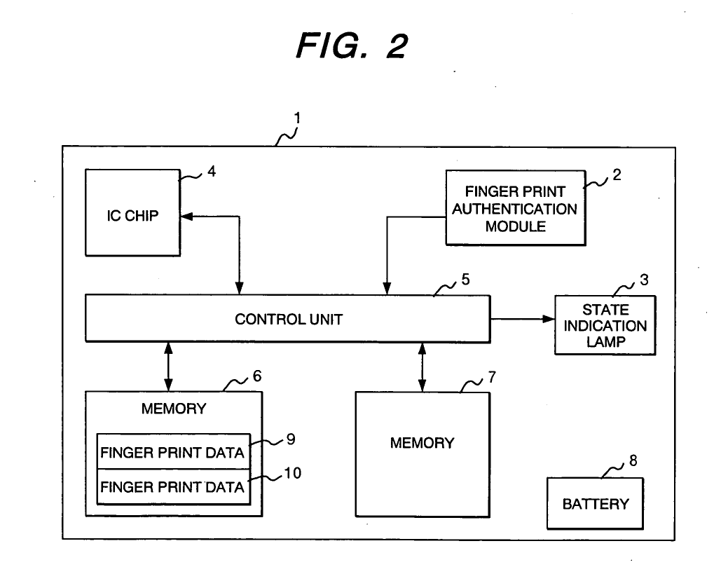

In FIG. 2, each function within the IC card in the present example will be described for each region using the block diagram. A memory 6 is a rewritable memory such as a random access memory, and retains finger print data of the owner. A memory 7 is a read-only memory in which a control program necessary for a control unit 5 to perform various control and fixed data such as control data and preset values have been recorded. The control unit 5 comprehensively controls retention, collation and erasing of finger print data, execution of various programs including various application programs, a state indication lamp and an IC chip, usage of IC cards by timer monitoring and the like. A battery 8 is used to supply electric power required for operating the control unit 5, the finger print module 3, the IC chip 4 and the state indication lamp 3.

Next, the description will be made of an operation of the IC card in the present example. In the beginning, a finger print of the owner is read by the finger print authentication module 2 mounted on the IC card 1 and finger print data 9 is registered in advance. The finger print data 9 which has been read by the finger print authentication module 2 is retained in the memory 6 through the control unit 5, and is registered as data of the owner. Next, when the owner uses the IC card 1, the finger print of the owner is read by the finger print authentication module 2, and finger print data 10 is retained in the memory 6 through the control unit 5.

The control unit 5 compares the finger print data 10 retained with the finger print data 9 registered as data of the owner in advance, and only when those data coincide with each other, the IC card 1 becomes usable, and the control unit 5 transmits a signal or data necessary for the IC chip. Also, when the IC card 1 enters a usable state, the control unit 5 causes the state indication lamp 3 to light, notifying the owner of usage availability. Thereafter, the control unit 5 monitors time, and after a lapse of a predetermined time period, releases the state of use to erase the finger print data 10 retained in the memory 6. At the same time, the control unit 5 causes the state indication lamp 3 to put out, and notifies the owner of usage non-availability. Thereby, even when the IC card which has become usable is lost or stolen, it is possible to prevent unfair use/use under the disguise by any other person than the owner because it is necessary to read the finger print data of the owner again.

As regards a condition for allowing continuous use during a time period from a time at which the finger print of the owner is read by the finger print authentication module 2 and the IC card enters an usable state to a time at which the state of use is released, a time period (term of validity) in this case is preferably as short a time as one minute to about five minutes in terms of preventing unfair use/use under the disguise. As regards setting of a release time period, by changing a preset value for release time period recorded in the memory 7, it is possible to set to a time period suitable for the use application of the IC card.

In this respect, as regards the preset value for release time period, in consideration of a time period necessary for collation of the principal before the IC card is used and a shortest time period in which there is a possibility that the IC card is lost or stolen and unfair use or use under the disguise occurs after collated by the principal in accordance with each of those objects of use, it is possible to set a time period until erasing adapted to the object of use or ease of use of the IC card.

Also, according to the present example, there is provided a function for setting a security level in such a manner that the security level in the collation of biometrics of the principal is changed in accordance with the object of use of the IC card (or each application program therein). In the case of, for example, finger print collation, it is made possible to set at how many places features of the finger print should be collated, whereby it is possible to prevent misidentification/unfair use of a similar finger print of any other person than the owner. Also, a number of fingers to be used for finger print collation is increased or an order of fingers in finger print collation is registered in advance, whereby it becomes possible to set intensity of the security level. As regards the content and preset value of the security level, they are retained in the memory 7 through the control unit 5 in advance.

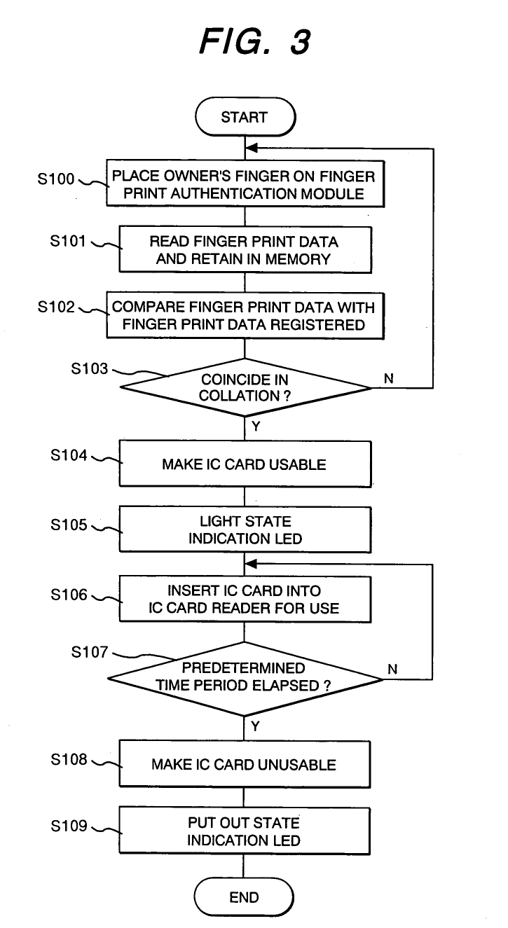

In a flowchart of FIG. 3, the description will be made of a function for reading the biometrics data in an IC card according to the present example to allow it usable for a predetermined time period. A finger of the owner is placed on the finger print authentication module 2 mounted on the IC card 1 (S100); and the finger print authentication module 2 reads finger print data of the owner and retains as the finger print data 10 of the memory 6 through the control unit 5 (S101) The control unit 5 compares and collates the finger print data 10 retained with the finger print data 9 of the owner which has been registered in the memory 6 in advance (S102). If as the result of comparison and collation of the finger print data 10 with the finger print data 9, they do not coincide, the finger print data 10 will be erased to return to the state of S100 (S103). If as the result of comparison and collation of the finger print data 10 with the finger print data 9, they coincide, the IC card 1 will be made into a usable state (S104). After the IC card 1 enters the usable state, the control unit 5 will cause the state indication lamp 3 to light, notifying the owner of a state in which the IC card 1 is usable (S105). The IC card 1 which has become usable will be inserted into an IC card reader/writer (not shown) by the owner for being used (S106)

The control unit 5 has monitored time since the state of S105, and monitors whether or not, a preset time period has elapsed (S107). When the preset time period has elapsed, the finger print data 10 retained in the memory 10 will be erased to shift the IC card 1 to an unusable state (S108). Also, the control unit 5 causes the state indication lamp 3 to put out, notifying the owner that the IC card 1 has shifted to the unusable state (S109). In order to make the IC card 1 usable, it is necessary to cause the finger print data of the owner to be read on the finger print authentication module 2 again.

In a case where the IC card 1 corresponds to a plurality of application, when the IC card is inserted into the IC card reader/writer, application to be used is specified. At this time, the control unit 5 will monitor time in accordance with information on the term of validity of the IC card set in advance for each application. Thereby, since the term of validity of the card can be changed in accordance with the object of use of the IC card, the security of the IC card is improved. For example, in a case where used as an ATM card of a bank, the term of validity of the card will be set to several seconds. Thereby, even if the card is dropped and picked up by a person in the neighborhood, since it becomes necessary to re-authenticate, it is possible to prevent use under the disguise. As described above, the term of validity of the IC card after collation of individual authentication will be changed in accordance with the object of use of the card.

According to the present example in the foregoing, there is provided a biometrics authentication module which can be confirmed by the owner, and there are a function for collating with the owner's biometrics data registered in advance; a function in which the IC card becomes usable in a case where when the IC card is used, it coincides with the biometrics data in which the biometrics data of the owner has been read and registered; and a function for erasing only the read biometrics data after a lapse of a predetermined time period to limit a time period of use of the IC card. Therefore, after an elapse of a predetermined time period after the principal collates and starts to use, the IC card cannot be used unless the biometrics data is collated again, but even when lost and stolen after the collation by the principal, it is possible to prevent unfair use/use under the disguise.

Also, as regards a time period during which only the read biometrics data is erased, it may be possible to set any time period in advance in accordance with the object of use of the IC card. Thereby, in consideration of a time period necessary for collation of the principal before the IC card is used and a shortest time period in which there is a possibility that the IC card is lost or stolen and unfair use or use under the disguise occurs after collated by the principal in accordance with each of those objects of use, it is possible to set a time period until erasing adapted to the object of use or ease of use of the IC card.

In the above-described examples, it has been rendered possible to set a time period during which only the read biometrics data is erased, but it may be possible to change the term of validity of the authentication result obtained by performing individual authentication when the biometrics data is inputted.

Also, as another example, a function capable of changing the security level in the collation by the principal of biometrics is combined with a time period setting function, whereby the ease of use and the security level of the IC card can be improved.

For example, a cash card or the like of a bank has a release time period of several seconds, and even if the cash card is dropped and is picked up by one of the neighbors on the spot, use under the disguise is prevented. At this time, when the cash card is used again several seconds later, finger print collation is set to a low level, or a security level at which a number of fingers to be collated is set to one is set to a lower level in advance, and when the cash card is used again several minutes later, finger print collation is set to a high level, or such a security level that a number of fingers to be collated is set to two or more and an order of fingers to be collated is registered is set to a higher level. It is possible to set such that the security level is raised with the passage of time as described above. Thereby, the ease of use and the security level of the IC card can be improved.

Also, as another example, it is also possible to set in consideration of a use environment of the IC card. In other words, between when the IC card or an application program therein is exclusively used in an environment in which there are the general public, and when it is exclusively used in such an environment as there are only specified people, it is preferable to set in a different way. For example, in an environment in which the IC card is inserted into a personal computer or the like within an office and the personal computer is made operable while the IC card is being inserted, it is conceivable that a release time period of the IC card is set to one hour, and collation by the principal is made every one hour.

As described above, according to the present invention, the IC card is provided with a biometrics recognition function and a use limitation function for a predetermined time period, whereby it is possible to reliably prevent unfair use/use under the disguise even when lost or stolen after collation by the principal.

Also, there is no possibility that a time period for erasing only the read biometrics data impairs the ease of use of the IC card because it has a function for being able to set any time period in accordance with the object of use and the use environment of the IC card in advance.

Also, the function for changing the security level in the collation by the principal of biometrics is combined with the time period setting function, whereby the ease of use and the security level of the IC card can be further improved. Or, also setting is made in consideration of the use environment of the IC card, whereby the ease of use and the security level of the IC card can be secured.

Also, a continuous use time period can be arbitrarily set, whereby this can be utilized not only for preventing unfair use by a third party and use under the disguise, but also for preventing unfair use of the IC card owner as an IC card issuing corporation. For example, unfair use for lending/transferring a commutation ticket for an electric train or a membership card to any other person than the principal can be prevented.

Also, since the collation by the principal, the term of validity and the security level can be set, the present invention will be able to be utilized for a ballot card in an electronic ballot system utilizing the Internet in future as another use application.

What is claimed is:

1. An IC card to be used for individual authentication or settlement comprising:
an input device for individual authentication information of a user of said IC card;
a use condition storage device for storing a term of validity of said authentication information or collation results of said authentication information and use conditions of said IC card; and
a controller for controlling the term of validity of said IC card on the basis of collation results of said authentication information with said use condition information.

2. The IC card according to claim 1,
wherein said input device for said individual authentication information is comprised of input devices for biometrics information concerning any of a finger print, an iris, a voiceprint and a retina print.

3. The IC card according to claim 1,
wherein said use condition storage device records a term of validity of said IC card for every application program of said IC card.

4. The IC card according to claim 1,
wherein said use condition storage device records judgment conditions during collation of individual authentication information inputted every application program of said IC card.

5. The IC card according to claim 1,
wherein said controller makes said IC card usable for a predetermined time period on the basis of individual authentication information inputted into said IC card, and makes said IC card unusable after a lapse of said time period.

6. The IC card according to claim 5,
wherein said IC card has a display unit for displaying whether or not said IC card can be used and
said controller lights said display unit when said IC card can be used, and puts out said display unit when said IC card cannot be used.

7. An IC card to be used for individual authentication or settlement, comprising functions for:
inputting finger print information of a user of said IC card;
collating said inputted finger print information with finger print information of a user of the IC card registered in advance; and
when the collation results in coincide, making said IC card valid during a predetermined terms of validity to make use of said IC card possible.

8. The IC card according to claim 7, further comprising a function for making use of said IC card impossible after an elapse of said predetermined time period.

9. The IC card according to claim 8,
wherein said IC card displays that said IC card is valid during said term of validity, and that said IC card is not valid after an elapse of said term of validity.

10. The IC card according to claim 7,
wherein said term of validity will be set in accordance with an object of use of said IC card.

11. The IC card according to claim 7,
wherein a collation condition of said finger print information will be set in accordance with an object of use of said IC card.

12. A method of controlling a term of validity of an IC card to be used for individual authentication or settlement, comprising the steps of:
inputting authentication information of a user of said IC card;
collating said authentication information inputted with authentication information of the user of said IC card registered in advance;
making said IC card usable when said collation results in coincidence;
monitoring an elapse of time period since said IC card is made usable; and
making said IC card unusable when a predetermined term of validity of said IC card has elapsed.

13. The method of controlling a term of validity of said IC card according to claim 12, further comprising a step of changing the term of validity of said IC card in accordance with an object of use of said IC card.
